(19) United States
(12) Patent Application Publication
(10) Pub. No.: US 2015/0089210 A1
(43) Pub. Date: Mar. 26, 2015

(54) ELECTRONIC DEVICE AND LOW BATTERY BOOT-UP METHOD

(71) Applicant: Chiun Mai Communication Systems, Inc., New Taipei (TW)

(72) Inventors: HSIN-CHANG LAI, New Taipei (TW); HAN-ZEN CHANG, New Taipei (TW); JIUN-RU HOU, New Taipei (TW); LIU-WEI WU, New Taipei (TW)

(21) Appl. No.: 14/493,981

(22) Filed: Sep. 23, 2014

(30) Foreign Application Priority Data
Sep. 26, 2013 (CN) 201310442545.3

(51) Int. Cl. G06F 9/44; G06F 1/32

(52) U.S. Cl. CPC G06F 9/442; G06F 9/4401; G06F 1/3203
USPC 713/2

(57) ABSTRACT

In a low battery boot-up method executed in an electronic device, boot configurations of the electronic device for low battery boot-up are set and stored in a storage device. When a user command to turn on the electronic device is received after the electronic device has shut down automatically due to low battery, the boot configurations are read from the storage device. The electronic device is controlled to boot-up according to the boot configurations and enter a low battery power-on state.

### CROSS-REFERENCE TO RELATED APPLICATIONS

This application claims priority to Chinese Patent Application No. 201310442545.3 filed on Sep. 26, 2013 in the China Intellectual Property Office, the contents of which are incorporated by reference herein.

### FIELD

The subject matter herein generally relates to boot-up of electronic devices.

### BACKGROUND

Batteries, such as lithium batteries, may be adopted to provide power to electronic devices, such as smart phones. When remaining battery capacity of an electronic device is below a predetermined level, such as 5 percents of full battery capacity, the electronic device may shut down automatically. However, a user may need to use the electronic device to deal with some emergencies (e.g., to dial an emergency number) in this case. Therefore, there is a need for booting the electronic device with low battery in a power saving mode.

### BRIEF DESCRIPTION OF THE DRAWINGS

Implementations of the present technology will now be described, by way of example only, with reference to the attached figures.

FIG. 1 is a block diagram of one example embodiment of a hardware environment for executing a low battery boot-up system.

FIG. 2 is a block diagram of one embodiment of a state transition graph of an electronic device.

FIG. 3 is a block diagram of one example embodiment of function modules of the low battery boot-up system in FIG. 1.

FIG. 4 is a flowchart of one example embodiment of a low battery boot-up method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

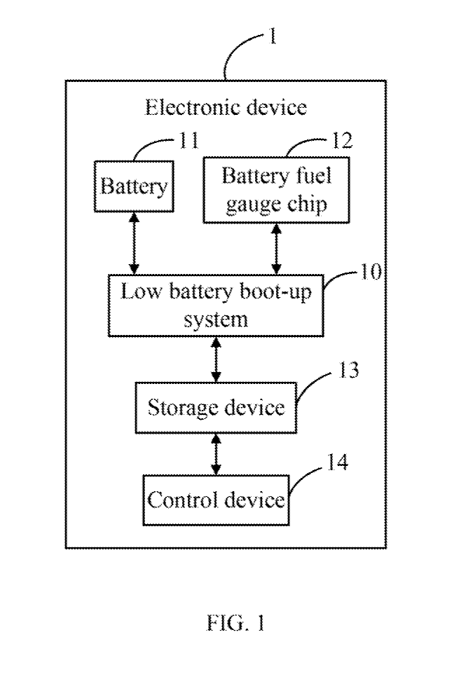

FIG. 1 is a block diagram of one example embodiment of a hardware environment for executing a low battery boot-up system 10. The low battery boot-up system 10 is installed and run in an electronic device 1. The electronic device 1 can include at least one battery 11, a battery fuel gauge chip 12, a storage device 13, and at least one control device 14.

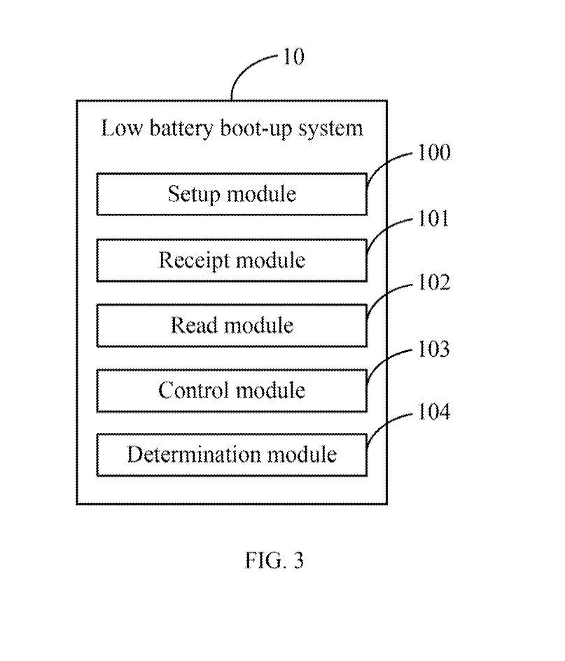

The low battery boot-up system 10 can include a plurality of function modules (shown in FIG. 3) that control the electronic device 1 to boot-up in a power saving mode after the electronic device 1 shuts down automatically due to low battery.

The at least one battery 11 provides power to the electronic device 1.

The battery fuel gauge chip 12 measures battery current and/or voltage of the electronic device 1, and calculates remaining battery capacity of the electronic device 1 according to the battery current and/or voltage.

The storage device 13 can include some type(s) of non-transitory computer-readable storage medium such as, for example, a hard disk drive, a compact disc, a digital video disc, or a tape drive. The storage device 13 stores the computerized codes of the function modules of the low battery boot-up system 10.

The control device 14 can be a processor, an application-specific integrated circuit (ASIC), or a field programmable gate array (FPGA), for example. The control device 14 can execute computerized codes of the function modules of the low battery boot-up system 10 to realize the functions of the electronic device 1.

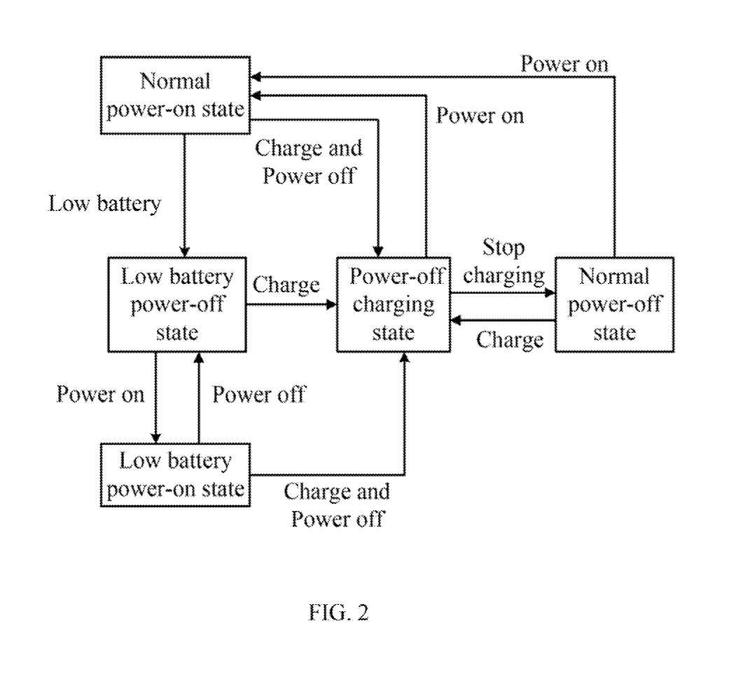

FIG. 2 is a block diagram of one embodiment of a state transition graph of the electronic device 1. The electronic device 1 can be in five states: a normal power-on state, a low battery power-off state, a low battery power-on state, a power-off charging state, and a normal power-off state. The electronic device 1 can switch among the different states. The electronic device 1 can switch from the normal power-on state to the lower battery power-off state if shutting down automatically due to low battery, or switch from the normal power-on state to the power-off charging state if charged and power off. The electronic device 1 can switch from the low battery power-off state to the low battery power-on state if power on, or switch from the low battery power-off state to the power-off charging state if charged. The electronic device 1 can switch from the low battery power-on state to the low battery power-off state if power off, or switch from the low battery power-on state to the power-off charging state if charged and power off. The electronic device 1 can switch from the power-off charging state to the normal power-on state if power on, or switch from the power-off charging state to the normal power-off state if charging is stopped. The electronic device 1 can switch from the normal power-off state to the normal power-on state if power on, and switch from the normal power-off state to the power-off charging state if charged.

FIG. 3 is a block diagram of one embodiment of function modules of the low battery boot-up system 10. The function modules can include a setup module 100, a receipt module 101, a read module 102, a control module 103, and a determination module 104. The function modules 100-104 can include computerized codes in the form of one or more programs, which provide at least the functions of the low battery boot-up system 10.

The setup module 100 is configured to set boot configurations of the electronic device 1 for low battery boot-up, and stores the boot configurations in the storage device 13. In one embodiment, the boot configurations can include to disable vibrating, animation, and sound in booting, to power off unused hardware, to reduce backlight level, to display a concise desktop, and to activate one or more specified functions of the electronic device 1. The specified function can be a call function, a Bluetooth function, or a GPS function, for example.

The receipt module 101 is configured to receive a user command to turn on the electronic device 1 after the electronic device 1 has shut down automatically due to low battery.

The read module 102 is configured to read the boot configurations of the electronic device 1 from the storage device 13.

The control module 103 is configured to control the electronic device 1 to boot-up according to the boot configurations and enter the low battery power-on state. For example, the control module 103 controls the electronic device 1 to disable vibrating, animation, and sound in booting, to power off unused hardware, to reduce backlight level, to display a concise desktop on a display screen of the electronic device 1, and to activate one or more specified functions of the electronic device 1.

The determination module 104 is configured to determine remaining battery capacity and remaining usage time of the electronic device 1, and display the remaining battery capacity and the remaining usage time on the display screen of the electronic device 1. In one embodiment, the battery fuel gauge chip 12 can measure battery current and/or voltage, and calculate the remaining battery capacity of the electronic device 1 according to the battery current and/or voltage. The determination module 104 can obtain the remaining battery capacity from the battery fuel gauge chip 12, and determine the remaining usage time according to the remaining battery capacity.

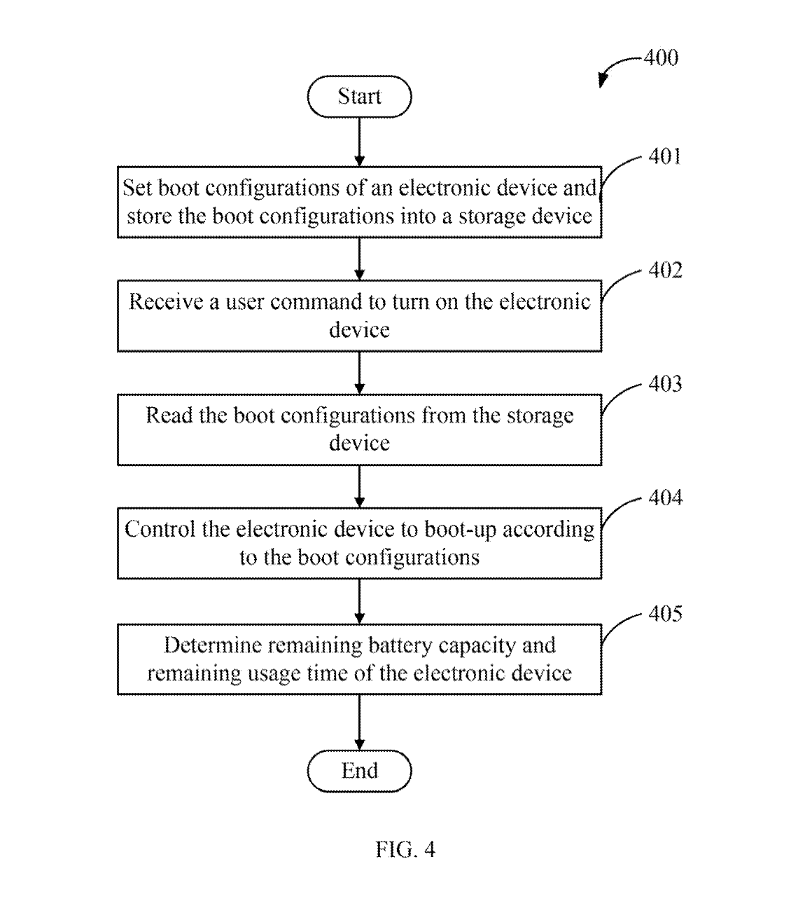

FIG. 4 is a flowchart of one example embodiment of a low battery boot-up method. In the embodiment, the method is performed by execution of computer-readable software program codes or instructions by the control device 14, such as at least one processor of the electronic device 1.

Referring to FIG. 4, a flowchart is presented in accordance with an example embodiment. The method 400 is provided by way of example, as there are a variety of ways to carry out the method. The method 400 described below can be carried out using the configurations illustrated in FIGS. 1-3, for example, and various elements of these figures are referenced in explaining method 400. Each block shown in FIG. 4 represents one or more processes, methods, or subroutines, carried out in the method 400. Furthermore, the illustrated order of blocks is illustrative only and the order of the blocks can be changed. Additional blocks can be added or fewer blocks may be utilized without departing from this disclosure. The method 400 can begin at block 401.

At block 401, a setup module sets boot configurations of an electronic device for low battery boot-up, and stores the boot configurations into a storage device of the electronic device. In one embodiment, the boot configurations can include to disable vibrating, animation, and sound in booting, to power off unused hardware, to reduce backlight level, to display a concise desktop, and to activate one or more specified functions of the electronic device. The specified function can be a call function, a Bluetooth function, or a GPS function, for example.

At block 402, a receipt module receives a user command to turn on the electronic device after the electronic device has shut down automatically due to low battery.

At block 403, a read module reads the boot configurations of the electronic device from the storage device.

At block 404, a control module controls the electronic device to boot-up according to the boot configurations and enter the low battery power-on state. For example, the control module controls the electronic device to disable vibrating, animation, and sound in booting, to power off unused hardware, to reduce backlight level, to display a concise desktop on a display screen of the electronic device, and to activate one or more specified functions of the electronic device.

At block 405, a determination module determines remaining battery capacity and remaining usage time of the electronic device, and displays the remaining battery capacity and the remaining usage time on the display screen of the electronic device. In one embodiment, a battery fuel gauge chip installed in the electronic device can measure battery current and/or voltage and calculate the remaining battery capacity of the electronic device according to the battery current and/or voltage. The determination module can obtain the remaining battery capacity from the battery fuel gauge chip and determine the remaining usage time according to the remaining battery capacity.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A low battery boot-up method being executed by at least one control device of an electronic device, the method comprising:
setting boot configurations of the electronic device for low battery boot-up;
storing the boot configurations in a storage device of the electronic device;
receiving a user command to turn on the electronic device after the electronic device has shut down automatically due to low battery;
reading the boot configurations from the storage device in response to the user command; and
controlling the electronic device to boot-up according to the boot configurations and enter a low battery power-on state.

2. The method according to claim 1, further comprising:
determining remaining battery capacity and remaining usage time of the electronic device; and
displaying the remaining battery capacity and the remaining usage time on a display screen of the electronic device.

3. The method according to claim 1, wherein the boot configurations comprises: a configuration for disabling vibrating, animation, and sound in booting, a configuration for powering off unused hardware, a configuration for reducing backlight level, a configuration for displaying a concise desktop, and a configuration for activating one or more specified functions of the electronic device.

4. The method according to claim 1, wherein the electronic device is in a low battery power-off state when the electronic device shuts down automatically due to low battery.

5. The method according to claim 4, wherein the electronic device switches from the low battery power-on state to the low battery power-off state when the electronic device is powered off, or switch from the low battery power-on state to a power-off charging state when the electronic device is charged.

6. An electronic device comprising:
a control device; and
a storage device storing one or more programs which when executed by the control device, causes the control device to perform operations comprising:
setting boot configurations of the electronic device for low battery boot-up;
storing the boot configurations in the storage device;
receiving a user command to turn on the electronic device after the electronic device has shut down automatically due to low battery;
reading the boot configurations from the storage device in response to the user command; and
controlling the electronic device to boot-up according to the boot configurations and enter a low battery power-on state.

7. The electronic device according to claim 6, wherein the operations further comprise:
determining remaining battery capacity and remaining usage time of the electronic device; and
displaying the remaining battery capacity and the remaining usage time on a display screen of the electronic device.

8. The electronic device according to claim 6, wherein the boot configurations comprises: a configuration for disabling vibrating, animation, and sound in booting, a configuration powering off unused hardware, a configuration for reducing backlight level, a configuration for displaying a concise desktop, and a configuration for activating one or more specified functions of the electronic device.

9. The electronic device according to claim 6, wherein the electronic device is in a low battery power-off state when the electronic device shuts down automatically due to low battery.

10. The electronic device according to claim 9, wherein the electronic device switches from the low battery power-on state to the low battery power-off state when the electronic device is powered off, or switch from the low battery power-on state to a power-off charging state when the electronic device is charged.

11. A non-transitory storage medium having stored thereon instructions that, when executed by a control device of an electronic device, causes the control device to perform a low battery boot-up method, the method comprising:
setting boot configurations of the electronic device for low battery boot-up;
storing the boot configurations in a storage device of the electronic device;
receiving a user command to turn on the electronic device after the electronic device has shut down automatically due to low battery;
reading the boot configurations from the storage device in response to the user command; and
controlling the electronic device to boot-up according to the boot configurations and enter a low battery power-on state.

12. The non-transitory storage medium according to claim 11, wherein the method further comprises:
determining remaining battery capacity and remaining usage time of the electronic device; and
displaying the remaining battery capacity and the remaining usage time on a display screen of the electronic device.

13. The non-transitory storage medium according to claim 11, wherein the boot configurations comprising: a configuration for disabling vibrating, animation, and sound in booting, to power off unused hardware, a configuration for reducing backlight level, a configuration for displaying a concise desktop, and a configuration for activating one or more specified functions of the electronic device.

14. The non-transitory storage medium according to claim 11, wherein the electronic device is in a low battery power-off state when the electronic device shuts down automatically due to low battery.

15. The non-transitory storage medium according to claim 14, wherein the electronic device switches from the low battery power-on state to the low battery power-off state when the electronic device is powered off, or switch from the low battery power-on state to a power-off charging state when the electronic device is charged.
